(19) United States
(12) Patent Application Publication
(10) Pub. No.: US 2025/0106296 A1
(43) Pub. Date: Mar. 27, 2025

(54) CONSTRAINT DEVICE IN EDGE COMPUTING

(71) Applicant: Telefonaktiebolaget LM Ericsson (publ), Stockholm (SE)

(72) Inventor: Wenliang XU, Shanghai (CN)

(21) Appl. No.: 18/730,831

(22) PCT Filed: Jan. 9, 2023
(86) PCT No.: PCT/CN2023/071278

§ 371 Date: Jul. 22, 2024

(30) Foreign Application Priority Data
Jan. 28, 2022 (WO) PCT/CN2022/074675

(51) Int. Cl. H04L 67/51; H04W 48/18

(52) U.S. Cl. CPC H04L 67/51; H04W 48/18

(57) ABSTRACT

The embodiments herein relate to constraint device in edge computing. In some embodiments, there proposes a method performed by a first functional component implementing an enabler function in a User Equipment (UE). In an embodiment, the method may include the step of performing a service provisioning, to obtain information regarding one or more first network functions implementing Edge Enabler Servers (EESs). In an embodiment, the method may further include the step of selecting a first network function from the one or more first network functions. In an embodiment, the method may further include the step of transmitting, to the selected first network function, a first message including a first parameter enabling the selected first network function to perform Edge Application Server (EAS) selection. In an embodiment, the method may further include the step of receiving, from the selected first network function, a second message.

### TECHNICAL FIELD

The embodiments herein relate generally to the field of edge computing, and more particularly, the embodiments herein relate to constraint device in edge computing.

### BACKGROUND

The third Generation Partnership Project (3GPP) Technical Specification (TS) 23.558 Release 17 (v17.1.0) specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1 is a schematic block diagram showing example architecture 100 for enabling edge applications. The Edge Data Network (EDN) 102 is a local data network. The Edge Application Server(s) (EAS) 122 and the Edge Enabler Server (EES) 121 are contained within the EDN 102. The Edge Configuration Server (ECS) 103 provides configurations related to the EES 121, including details of the EDN 102 hosting the EES 121. The User Equipment (UE) 101 contains Application Client(s) (AC) 112 and the Edge Enabler Client (EEC) 111. The EAS(s) 122, the EES(s) 121 and the ECS 103 may interact with the 3GPP Core Network 104.

There are several unsolved key issues when discussing the next release, for example Release 18.

### SUMMARY

The embodiments herein propose methods, UEs, network functions, computer readable medium and computer program product for constraint device in edge computing.

In some embodiments, there proposes a method performed by a first functional component implementing an enabler function in a UE. In an embodiment, the method may comprise the step of performing a service provisioning, to obtain information regarding one or more first network functions implementing EESs. The method may further comprise the step of selecting a first network function from the one or more first network functions. The method may further comprise the step of transmitting, to the selected first network function, a first message including a first parameter enabling the selected first network function to perform EAS selection. The method may further comprise the step of receiving, from the selected first network function, a second message.

In an embodiment, the step of selecting may further comprise selecting the first network function which the registration of the first functional component on the first network function is not required.

In an embodiment, the second message may include a second parameter indicating information regarding a second network function implementing EAS.

In an embodiment, the first parameter may indicate whether the EAS selection is delegated to the selected first network function.

In an embodiment, the second parameter may indicate the profile (e.g., endpoint) of the second network function selected by the selected first network function.

In an embodiment, the second message may not include information regarding a second network function implementing EAS. In this embodiment, the method may further comprise the step of selecting another first network function from the one or more first network functions. The method may further comprise the step of transmitting, to said another first network function, a third message including the first parameter enabling said another first network function to perform EAS selection. The method may further comprise the step of receiving, from said another first network function, a fourth message including the second parameter indicating information regarding a second network function implementing EAS.

In some embodiments, there proposes a method performed by a first functional component implementing an enabler function in a UE. In an embodiment, the method may comprise the step of performing a service provisioning, to obtain information regarding one or more first network functions implementing EESs. The method may further comprise the step of selecting a first network function from the one or more first network functions. The registration of the first functional component on the selected first network function may be not required. The method may further comprise the step of transmitting, to the selected first network function, a first message for discovering a second network function implementing EAS. The method may further comprise the step of receiving, from the selected first network function, a second message.

In an embodiment, the step of transmitting may further comprise the step of transmitting, to the selected first network function, a first message for discovering a second network function implementing EAS. The first message may include a first parameter enabling the selected first network function to perform EAS selection, for example the first parameter may indicate whether the EAS selection is delegated to the selected first network function.

In an embodiment, the step of receiving may further comprise the step of receiving, from the selected first network function, a second message including a second parameter indicating information regarding a selected second network function implementing EAS.

In an embodiment, the second message may not include information regarding a second network function implementing EAS. In this embodiment, the method may further comprise the step of selecting another first network function from the one or more first network functions. The method may further comprise the step of transmitting, to said another first network function, a third message for discovering a second network function implementing EAS. The method may further comprise the step of receiving, from said another first network function, a fourth message including information regarding a second network function implementing EAS.

In some embodiments, there proposes a method performed by a first network function implementing EES. In an embodiment, the method may comprise the step of receiving, from a first functional component implementing an enabler function in a UE, a first message including a first parameter enabling the selected first network function to perform EAS selection. The method may further comprise the step of performing an EAS discovery, to discover one or more second network functions. The method may further comprise the step of selecting a second network function from the one or more second network functions. The method may further comprise the step of transmitting, to the first functional component, a second message including a second parameter indicating information regarding the selected second network function.

In an embodiment, the registration of the first functional component on the first network function may be not required.

In an embodiment, the first parameter may indicate whether the EAS selection is delegated to the first network function.

In an embodiment, the second parameter may indicate the profile of the second network function selected by the first network function.

In some embodiments, there proposes a UE, comprising: at least one processor; and a non-transitory computer readable medium coupled to the at least one processor. In an embodiment, the non-transitory computer readable medium may store instructions executable by the at least one processor, whereby the at least one processor may be configured to perform the above method. In an embodiment, the UE may be configured as the above UE.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above method. In an embodiment, the network function may be configured as the above first network function.

In some embodiments, there proposes a computer readable medium stores computer readable code, which when run on an apparatus, causes the apparatus to perform any of the above methods.

In some embodiments, there proposes a computer program product stores computer readable code, which when run on an apparatus, causes the apparatus to perform any of the above methods.

The embodiments herein allow to skip the EEC registration and/or to delegate the EAS selection to EES, thus the embodiments herein may optimize the EAS discovery and selection procedure especially for battery-powered constraint device, to reduce power consumption in such device.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for enabling Edge applications;

FIG. 2 is a schematic signaling chart showing the messages in an EAS discovery and selection procedure, according to the embodiments herein;

FIG. 3A is a schematic signaling chart showing the messages in a service provisioning request-response procedure;

FIG. 3B is a schematic signaling chart showing the messages in a service provisioning subscription-notification procedure;

FIG. 4A is a schematic signaling chart showing the messages in an EAS discovery request-response procedure, according to the embodiments herein;

FIG. 4B is a schematic signaling chart showing the messages in an EAS discovery subscription-notification procedure, according to the embodiments herein;

FIG. 5 is a schematic flow chart showing an example method in the UE, according to the embodiments herein;

FIG. 6 is a schematic flow chart showing an example method in the first network function, according to the embodiments herein;

FIG. 7 is a schematic block diagram showing an example UE, according to the embodiments herein;

FIG. 8 is a schematic block diagram showing an example first network function, according to the embodiments herein;

FIG. 9 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

The edge computing study TR 23.700-98 v0.4.0 describes several Key Issues (KIs).

KI #15 (Support of constrained devices for Edge) says:

“Energy efficiency requirements are relevant for battery driven low-power IoT devices. Those devices may require edge computing services in a local DN for low-latency and employ the SA6 specified edge enablers.

In the existing EDGEAPP architecture as described in TS 23.558, many procedures and services are defined for EEC to interaction with EES/ECS. It is needed to study what impact the support for constrained UE may have on EDGEAPP architecture and what procedure can be improved.

### Open Issues:

Whether there are any impacts on the EDGEAPP architecture for constrained UE.
Whether and how the existing EDGEAPP architecture and procedures, for constrained UE to network communication (i.e. EDGE-1 and EDGE-4), e.g. can be improved to reduce power consumption”.

In view of deficiencies with the current EAS discovery and selection procedure, the embodiments propose a solution for optimizing the EAS discovery and selection procedure of battery-powered constraint device, to reduce power consumption in such device (e.g. move computing task to network side).

The embodiments propose mechanism needed to support constrained UE (e.g. EAS selection delegation), the minimum set of EDGEAPP services are also identified for such a UE.

In an embodiment, the wireless communication system 100 may be configured in an OTT scenario. The OTT connection may be transparent in the sense that the participating communication devices through which the OTT connection passes are unaware of routing of uplink and downlink communications. For example, a base station may not or need not be informed about the past routing of an incoming downlink communication with data originating from the EAS 122, EES 121, or ECS 103 to be forwarded (e.g., handed over) to a connected UE 101. Similarly, the base station need not be aware of the future routing of an outgoing uplink communication originating from the UE 101 towards the EAS 122, EES 121, or ECS 103.

It should also be understood that, a network function can be implemented either as a network element on a dedicated hardware, as a software instance running on a dedicated hardware, or as a virtualized function instantiated on an appropriate platform, e.g. on a cloud infrastructure.

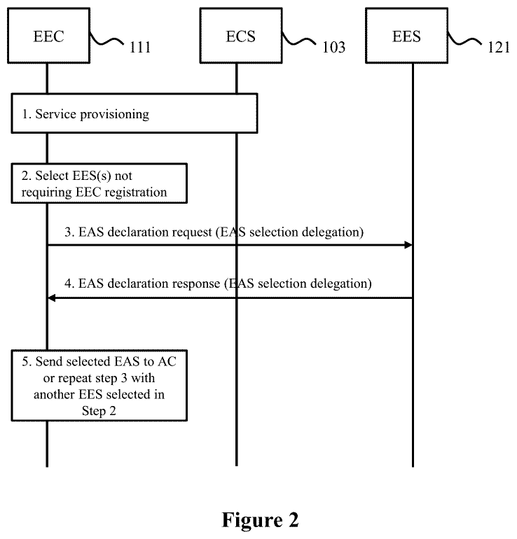

FIG. 2 is a schematic signaling chart showing the messages in an EAS discovery and selection procedure, according to the embodiments herein.

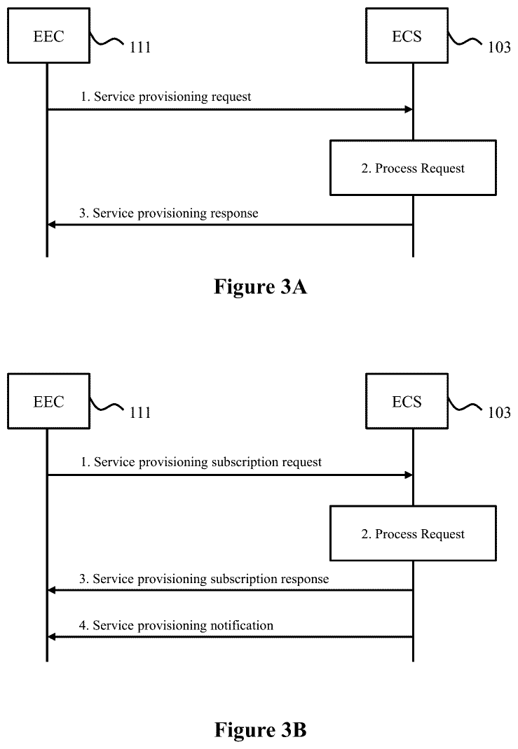

In an embodiment, the signaling chart may include the following messages or steps:
Step 1: The EEC 111 may perform a service provisioning procedure with the ECS 103. In response, the ECS 103 may provide information (for example, address or endpoint information) of one or more EESs 121 to the EEC 111. More details will be described by referring to FIGS. 3A and 3B.
Step 2: The EEC 111 may select an EES 121 from the one or more EESs 121, for performing further EAS discovery. For example, the EEC 111 may select the EES 121 which does not require EEC registration. However, if such EES 121 is not available, the EEC 111 may select an EES which requires EEC registration. If so, the EEC 111 may perform an EEC registration on the selected EES.
Step 3: The EEC 111 may send the EAS discovery request to the selected EES 121. In this request, the EEC 111 may enable the selected EES 121 to perform EAS selection for the EEC 111, that is, the EEC 111 may have the selected EES 121 being delegated to perform the EAS selection. For example, the EEC 111 may indicate the EAS delegation explicitly/implicitly indicate such delegation to delegate the EAS selection to the EES 121.

The following table 1 describes information elements for the EAS discovery request sent from the EEC 111 to the selected EES 121.

TABLE 1
EAS discovery request

| Information element | Status | Description |
|---|---|---|
| Requestor identifier | M | The ID of the requestor (e.g. EECID) |
| UE Identifier | O | The identifier of the UE (i.e. GPSI or identity token) |
| Security credentials | M | Security credentials resulting from a successful |
| | | authorization for the edge computing service. |
| EAS discovery filters | O | Set of characteristics to determine required EASs, |
| | | as detailed in Table 8.5.3.2-2. |
| UE location | O | The location information of the UE. The UE location |
| | | is described in clause 7.3.2. |
| Target DNAI (NOTE) | O | Target DNAI information which can be associated |
| | | with potential T-EAS(s) |
| EEC Service Continuity Support | O | Indicates if the EEC supports service continuity or |
| | | not. The IE also indicates which ACR |
| | | scenarios are supported by the EEC or, if this |
| | | message is sent by the EEC to discover a |
| | | T-EAS, which ACR scenario(s) are intended |
| | | to be used for the ACR. |
| EES Service Continuity Support | O | The IE indicates if the S-EES supports service |
| (NOTE) | | continuity or not. The IE also indicates which |
| | | ACR scenarios are supported by the S-EES |
| | | or, if the EAS discovery is used for an S-EES |
| | | executed ACR according to clause 8.8.2.5, |
| | | which ACR scenario is to be used for the |
| | | ACR. |
| EAS Service Continuity Support | O | The IE indicates if the S-EAS supports service |
| (NOTE) | | continuity or not. The IE also indicates which |
| | | ACR scenarios are supported by the S-EAS |
| | | or, if the EAS discovery is used for an S-EAS |
| | | decided ACR according to clause 8.8.2.4, |
| | | which ACR scenario is to be used for the |
| | | ACR. |
| EAS Selection Delegation | O | This IE indicates whether the EAS selection is |
| indication | | delegated to EES. Default value is false if |
| | | omitted. |

(NOTE):
This IE shall not be included when the request originates from the EEC.

As shown in table 1, a new information element “EAS Selection Delegation indication” may be added into the EAS discovery request to indicate whether the EAS selection is delegated to EES. The default value for “EAS Selection Delegation indication” is “false”, if omitted.

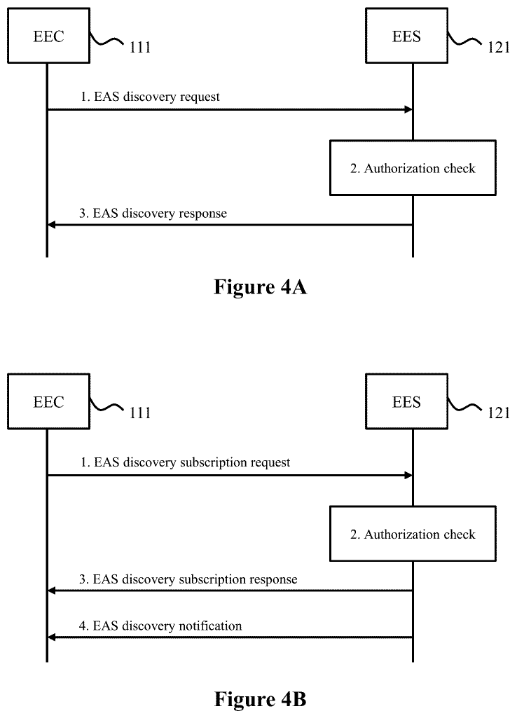

Step 4: upon the EAS discovery request is received, the EES 121 may perform an EAS discovery accordingly. If the information element “EAS Selection Delegation indication” is set as “true”, the EES 121 may select a suitable EAS 122 from discovered candidate EAS(s), then the EES 121 may send EAS discovery response to the EEC 111 including the information regarding the selected EAS, for example the EAS profile. Otherwise, if the information element “EAS Selection Delegation indication” is set as “false” or there is no information element “EAS Selection Delegation indication” in the EAS discovery, the EES 121 may send EAS discovery response to the EEC 111 including the information regarding all candidate EAS(s). More details will be described by referring to FIGS. 4A and 4B.

The following table 2 describes information elements for the EAS discovery response sent from the EES 121 to the EEC 111.

TABLE 2
EAS discovery response

| Information | | |
|---|---|---|
| element | Status | Description |
| Successful | O | Indicates that the EAS discovery request |
| response | | was successful. |
| > Discovered | O | List of discovered EAS(s). Each element |
| EAS list | | includes the information described below. |
| >> EAS profile | M | Profile of the EAS. Each element is |
| | | described in clause 8.2.4 |
| >> Lifetime | O | Time interval or duration during which the |
| | | information elements in the EAS profile is |
| | | valid and supposed to be cached in the EEC |
| | | (e.g. time-to-live value for an EAS Endpoint) |
| > Selected | O | Indicates the selected EAS profile by the |
| EAS profile | | EES. |
| Failure | O | Indicates that the EAS discovery request |
| response | | failed. |
| > Cause | O | Indicates the cause of EAS discovery request |
| | | failure. |

As shown in table 2, a new information element “Selected EAS profile” is added into the EAS discovery response to indicate the information (such as EAS profile) of the EAS 122 selected by the EES 121.
Step 5: If the EAS discovery response contains successful result, for example the EAS discovery response includes information of the EAS 122 selected by the EES 121, then the EEC 111 may send the received selected EAS information to the AC 112, and the EAS discovery and selection procedure ends.

In some embodiments, if the EAS discovery response includes information of more than one EAS 122, then the EEC 111 may cooperate with the AC 112 to select an EAS 122 therefrom. For example, the selection may be performed at the AC 112 side, the EEC 111 side, or the AC 112 and the EEC 111 may work together to decide the selected EAS 122.

Otherwise, if the EAS discovery response does not include information of any EAS, then the EEC 111 may repeat the above steps 2-5 (or only repeat the steps 2-4) with a next selected candidate EES.

In service continuity, to offload UE from monitoring triggers (e.g. location change) to start Application Context Relocation (ACR), the EEC 111 can announce its support for EDN side decided ACR scenarios so that the EEC 111 only need to passively receive ACR information notifications.

In contrast, in the existing logic for EAS selection, after service provisioning, the EEC has a list of candidate EES(s) that can satisfy the need for further EAS discovery, then the EEC sends EAS discovery request to each candidate EES and receives a list of candidate EAS(s) from each candidate EES. When multiple EASs are discovered for a specific AC, the EEC may select one or more EASs to enable AC communication with one of the selected EASs.

The EAS discovery and selection procedure shown in FIG. 2 may allow to skip the EEC registration in step 2, and/or may allow delegate the EAS selection to the EES in steps 3 and 4, thus may optimize the EAS discovery and selection procedure especially for battery-powered constraint device, to reduce power consumption in such device.

FIG. 3A is a schematic signaling chart showing the messages in a service provisioning request-response procedure. In an embodiment, the service provisioning request-response procedure of FIG. 3A may be implemented as step 1 of FIG. 2.

In an embodiment, the messages in the service provisioning request-response procedure of FIG. 3A may be transmitted over EDGE-4 reference point, which enables interactions between the ECS 103 and the EEC 111. The EDGE-4 reference point supports: a) provisioning of Edge configuration information to the EEC.

In an embodiment, the signaling chart in FIG. 3A may include the following messages or steps:
Step 1: The EEC 111 may send a service provisioning request to the ECS 103. The service provisioning request may include the UE identifier such as Generic Public Subscription Identifier (GPSI), connectivity information, UE location and AC profile(s) information.
Step 2: Upon receiving the request, the ECS 103 may perform an authorization check to verify whether the EEC 111 has authorization to perform the operation. If AC profile(s) are provided by the EEC 111, the ECS 103 may identify the EES(s) based on the provided AC profile(s) and the UE location. When AC profiles(s) are not provided, then: if available, the ECS 103 may identify the EES(s) based on the UE-specific service information at the ECS 103 and the UE location; or the ECS 103 may identify the EES(s) by applying the Edge Computing Service Provider (ECSP) policy (e.g. based only on the UE location). The ECS 103 may also determine other information that needs to be provisioned, e.g. identification of the EDN, EDN service area, EES endpoints.
Step 3: If the processing of the request was successful, the ECS 103 may respond to the EEC's request with a service provisioning response which may include a list of EDN configuration information, e.g. identification of the EDN, EDN service area, and the required information (e.g. URI, IP address) for establishing a connection to the EES 121. The EEC 111 may cache the service provisioning information (e.g. EES endpoint) for subsequent use and avoid the need to repeat step 1.

In addition, the ECS 103 may reject the service provisioning request and respond with an appropriate failure cause.

FIG. 3B is a schematic signaling chart showing the messages in a service provisioning subscription-notification procedure. In an embodiment, the service provisioning subscription-notification procedure of FIG. 3B may be implemented as step 1 of FIG. 2.

In an embodiment, the messages in the service provisioning subscription-notification procedure of FIG. 3B may be transmitted over EDGE-4 reference point, which enables interactions between the ECS 103 and the EEC 111. The EDGE-4 reference point supports: a) provisioning of Edge configuration information to the EEC.

In an embodiment, the signaling chart in FIG. 3B may include the following messages or steps:
Step 1: The EEC 111 may send a service provisioning subscription request to the ECS 103. The service provisioning subscription request may include Notification Target Address (e.g. URL) and may include the UE identifier such as GPSI, connectivity information, proposed expiration time and AC Profile information.
Step 2: Upon receiving the request, the ECS 103 may perform an authorization check to verify whether the EEC 111 has authorization to perform the operation. If required, the ECS 103 may utilize the capabilities (e.g. UE location or user plane management event notification service if available) of the 3GPP core network 104. If the request is authorized, the ECS 103 may create and store the subscription for provisioning.
Step 3: If the processing of the request was successful, the ECS 103 may respond with a service provisioning subscription response.

In addition, the ECS 103 may reject the service provisioning subscription request and respond with an appropriate failure cause.
Step 4: An event occurs at the ECS 103 that satisfies trigger conditions for updating service provisioning of a subscribed EEC 111. If AC profile(s) were provided by the EEC 111 during subscription creation, the ECS 103 may identify the EES(s) based on the provided AC profile(s) and the UE location. If AC profiles(s) were not provided, then: if available, the ECS 103 may identify the EES(s) based on the UE-specific service information at the ECS 103 and the UE location; or the ECS 103 may identify the EES(s) 121 by applying the ECSP policy (e.g. based only on the UE location). The ECS 103 may also determine other information that needs to be provisioned, e.g. identification of the EDN, EDN service area, EES endpoints. Then, the ECS 103 may send a provisioning notification to the EEC 111 with the list of EDN configuration information as determined.

FIG. 4A is a schematic signaling chart showing the messages in an EAS discovery request-response procedure, according to the embodiments herein. In an embodiment, the EAS discovery request-response procedure of FIG. 4A may be implemented as steps 3 and 4 of FIG. 2.

In an embodiment, the messages in the service provisioning request-response procedure of FIG. 4A may be transmitted over EDGE-1 reference point, which enables interactions between the EES 121 and the EEC 111. It supports: a) registration and de-registration of the EEC to the EES; b) retrieval and provisioning of EAS configuration information; and c) discovery of EASs available in the EDN.

In an embodiment, the signaling chart in FIG. 4A may include the following messages or steps:
Step 1: The EEC 111 may send an EAS discovery request to the EES 121. The EAS discovery request may include the requestor identifier, for example, EECID, along with the security credentials and may include EAS discovery filters and may also include UE location to retrieve information about particular EAS(s) or a category of EASs, e.g. gaming applications, or Edge Applications Server(s) available in certain service areas, e.g. available on a UE's predicted or expected route.
Step 2: Upon receiving the request from the EEC 111, the EES 121 may check if the EEC 111 is authorized to discover the requested EAS(s). The authorization check may apply to an individual EAS, a category of EASs or to the EDN, i.e. to all the EASs. If EAS discovery filters are provided by the EEC 111, the EES 121 may identify the EAS(s) based on the provided EAS discovery filters and the UE location. When EAS discovery filters are not provided, then: if available, the EES 121 may identify the EAS(s) based on the UE-specific service information at the EES 121 and the UE location; or the EES 121 may identify the EAS(s) by applying the ECSP policy (e.g. based only on the UE location).

The EES 121 may check whether the information element “EAS Selection Delegation indication” is set as “true”. If so, the EES 121 may select a suitable EAS 122 from discovered candidate EAS(s).
Step 3: If the processing of the request was successful, the EES 121 may send an EAS discovery response to the EEC 111, which may include information about the discovered/selected EAS(s). If the information element “EAS Selection Delegation indication” is set as “true”, the EES 121 may include the information of the selected EAS. Otherwise, if the information element “EAS Selection Delegation indication” is set as “false” or there is no information element “EAS Selection Delegation indication” in the EAS discovery, the EES 121 may include the information of the discovered EAS(s). For the selected/discovered EAS(s), such information may include endpoint information. The EAS discovery response may contain a list of EASs.

In addition, the EES 121 may reject the EAS discovery request and respond with an appropriate failure cause.

FIG. 4B is a schematic signaling chart showing the messages in an EAS discovery subscription-notification procedure, according to the embodiments herein. In an embodiment, the EAS discovery subscription-notification procedure of FIG. 4B may be implemented as steps 3 and 4 of FIG. 2.

In an embodiment, the messages in the service provisioning request-response procedure of FIG. 4B may be transmitted over EDGE-1 reference point, which enables interactions between the EES 121 and the EEC 111. It supports: a) registration and de-registration of the EEC to the EES; b) retrieval and provisioning of EAS configuration information; and c) discovery of EASs available in the EDN.

In an embodiment, the signaling chart in FIG. 4B may include the following messages or steps:
Step 1: The EEC 111 may send an EAS discovery subscription request to the EES 121. The EAS discovery subscription request may include the EECID along with the security credentials, Event ID, and may include EAS discovery filters and EAS dynamic information filters to subscribe to information about particular EAS(s) or a category of EASs (e.g. gaming applications) or dynamic information about EAS(s).
Step 2: Upon receiving the request from the EEC 111, the EES 121 may check if the EEC 111 is authorized to subscribe for information of the requested EAS(s). The authorization check may apply to an individual EAS, a category of EASs or to the EDN, i.e. to all the EASs. If the request is authorized, the EES 121 may create and store the subscription for EAS discovery.
Step 3. If the processing of the request was successful, the EES 121 may send an EAS discovery subscription response to the EEC 111.

In addition, the EES 121 may reject the EAS discovery subscription request and respond with an appropriate failure cause.
Step 4: An event occurs at the EES 121 that satisfies trigger conditions for notifying (e.g. to provide EAS discovery information or EAS dynamic information) a subscribed EEC.

If EAS discovery filters are provided by the EEC 111 during subscription creation, the EES 121 may identify the EAS(s) based on the provided EAS discovery filters and the UE location. If EAS discovery filters were not provided, then: if available, the EES 121 may identify the EAS(s) based on the UE-specific service information at the EES 121 and the UE location; or the EES 121 may identify the EAS(s) by applying the ECSP policy (e.g. based only on the UE location).

The EES 121 may check whether the information element “EAS Selection Delegation indication” is set as “true”. If so, the EES 121 may select a suitable EAS 122 from discovered candidate EAS(s).

Then, the EES 121 may send an EAS discovery notification to the EEC 111 with the EAS information as determined, which may include information about the discovered/selected EAS(s). If the information element “EAS Selection Delegation indication” is set as “true”, the EES 121 may include the information of the selected EAS. Otherwise, if the information element “EAS Selection Delegation indication” is set as “false” or there is no information element “EAS Selection Delegation indication” in the EAS discovery, the EES 121 may include the information of the discovered EAS(s). For the selected/discovered EAS(s), such information may include endpoint information. The EAS discovery response may contain a list of EASs.

The embodiments address the above KI #15. In the embodiments, in order to reduce power consumption in the constrained device using EDGEAPP, the embodiments specify the EEC with Reduced Capabilities (e.g., RedEEC). The RedEEC may skip EEC registration and/or the EAS discovery procedure is enhanced to delegate the EAS selection to the EES. The embodiments provide a minimum set of EDGE-1 interactions which help to reduce power consumption in the UE.

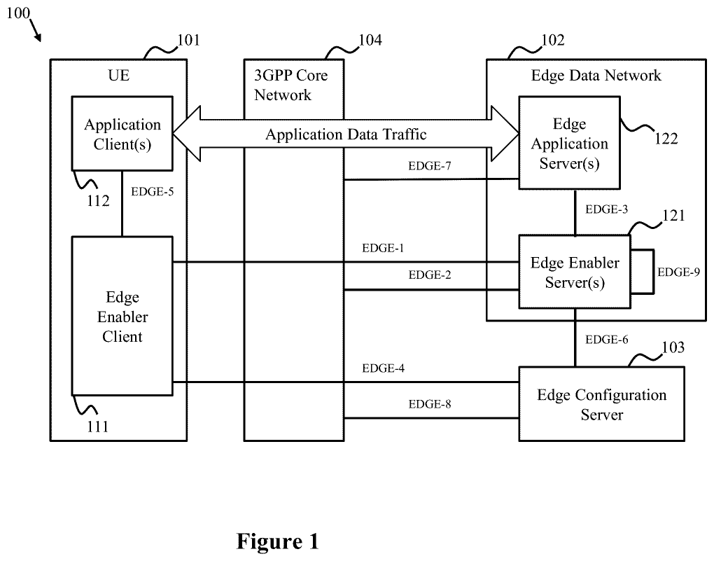

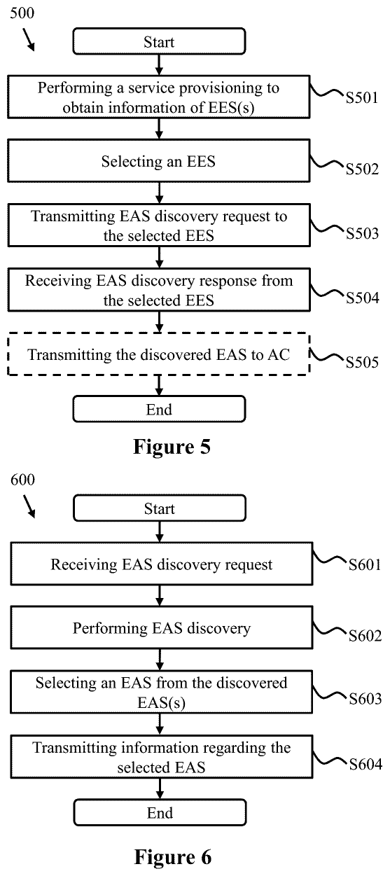

FIG. 5 is a schematic flow chart showing an example method 500 in the UE, according to the embodiments herein. In an embodiment, the flow chart in FIG. 5 may be implemented in the first functional component (such as EEC 111) in FIGS. 1-4B.

The method 500 may begin with step S501, in which the first functional component (such as EEC 111) may perform a service provisioning for example with a third network function (such as the ECS 103), to obtain information regarding one or more first network functions implementing EESs (such as the EES 121), as shown in above description in connect with FIG. 2, FIG. 3A, and FIG. 3B.

Then, the method 500 may proceed to step S502, in which the first functional component (such as EEC 111) may select a first network function from the one or more first network functions.

In an embodiment, the first functional component may select a first network function for which the registration of the first functional component is not required, as shown in above description in connect with FIG. 2.

Note that, in another embodiment, the first functional component may select a first network function for which the registration of the first functional component is required. In this embodiment, the first functional component should perform a registration on the selected first network function at first, as shown in above description in connect with FIG. 2.

Then, the method 500 may proceed to step S503, in which the first functional component (such as EEC 111) may transmit, to the selected first network function, a first message including a first parameter enabling the selected first network function to perform EAS selection.

In an embodiment, the first parameter may indicate whether the EAS selection is delegated to the selected first network function, as shown in above description in connect with FIG. 2, FIG. 4A, and FIG. 4B.

Note that, in another embodiment, it is also possible that the first functional component does not make the delegation, as shown in above description in connect with FIG. 2, FIG. 4A, and FIG. 4B.

Then, the method 500 may proceed to step S504, in which the first functional component (such as EEC 111) may receive, from the selected first network function, a second message.

In an embodiment, the second message may include a second parameter indicating information regarding a second network function implementing EAS, as shown in above description in connect with FIG. 2, FIG. 4A, and FIG. 4B.

In an embodiment, the second parameter may indicate the profile (e.g., endpoint) of the second network function selected by the selected first network function.

In an embodiment, the second message may not include information regarding a second network function implementing EAS. In this embodiment, the first functional component may repeat the steps S502 to S504 with a new first network function. The first functional component may repeatedly perform the above steps S502 to S504 until an available second network function is determined.

For example, in the step S502, the first functional component may select another first network function from the one or more first network functions. Then, in the step S503, the first functional component may transmit, to said another first network function, a third message including the first parameter enabling said another first network function to perform the EAS selection. Then, in the step S504, the first functional component may receive, from said another first network function, a fourth message including the second parameter indicating information regarding a second network function implementing EAS.

In an embodiment, the first to fourth messages are transmitted over the Edge-1 reference point.

Then, the method 500 may proceed to an optional step S505, in which the first functional component (such as EEC 111) may transmit, to a second functional component (such as AC 112) implementing application function in the UE, information regarding the second network function determined by the above steps, as shown in above description in connect with FIG. 2.

The above steps are only examples, and the first functional component may perform any actions described with respect to FIGS. 1-4B.

FIG. 6 is a schematic flow chart showing an example method 600 in the first network function, according to the embodiments herein. In an embodiment, the flow chart in FIG. 6 may be implemented in the first network function (such as EES 121) in FIGS. 1-4B.

The method 600 may begin with step S601, in which the first network function (such as EES 121) may receive, from a first functional component (such as EEC 111) implementing an enabler function in a UE, a first message including a first parameter enabling the first network function to perform EAS selection, as shown in above description in connect with FIG. 2, FIG. 4A, and FIG. 4B.

In an embodiment, the registration of the first functional component on the first network function may be not required.

In an embodiment, the first parameter may indicate whether the EAS selection is delegated to the first network function.

Then, the method 600 may proceed to step S602, in which the first network function (such as EES 121) may perform an EAS discovery, to discover one or more second network functions.

Then, the method 600 may proceed to step S603, in which the first network function (such as EES 121) may select a second network function from the one or more second network functions for the first functional component (such as EEC 111) in the UE.

Then, the method 600 may proceed to step S604, in which the first network function (such as EES 121) may transmit, to the first functional component, a second message including a second parameter indicating information regarding the selected second network function.

In an embodiment, the second parameter may indicate the profile of the second network function selected by the first network function

The above steps are only examples, and the first network function may perform any actions described with respect to FIGS. 1-4B.

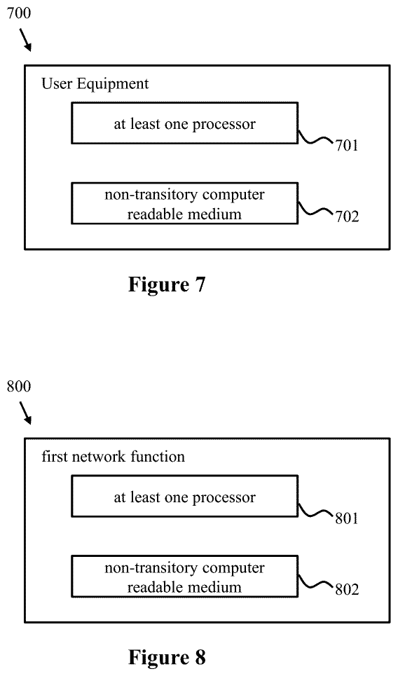

FIG. 7 is a schematic block diagram showing an example UE, according to the embodiments herein.

In an embodiment, the UE 700 may include at least one processor 701; and a non-transitory computer readable medium 702 coupled to the at least one processor 701. The non-transitory computer readable medium 702 may store instructions executable by the at least one processor 701, whereby the at least one processor 701 is configured to perform the steps in the example method 500 as shown in the schematic flow chart of FIG. 5; the details thereof are omitted here.

Note that, the UE 700 may be implemented as hardware, software, firmware and any combination thereof. For example, the UE 700 may include a plurality of units, circuities, modules or the like, each of which may be used to perform one or more steps of the example method 500 or one or more steps shown in FIGS. 1-4B related to the UE 101 and its functional component (such as EEC 111 and/or AC 112).

FIG. 8 is a schematic block diagram showing an example first network function (such as the EES(s) 121), according to the embodiments herein.

In an embodiment, the first network function 800 may include at least one processor 801; and a non-transitory computer readable medium 802 coupled to the at least one processor 801. The non-transitory computer readable medium 802 may store instructions executable by the at least one processor 801, whereby the at least one processor 801 is configured to perform the steps in the example method 600 as shown in the schematic flow chart of FIG. 6; the details thereof are omitted here.

Note that, the first network function 800 may be implemented as hardware, software, firmware and any combination thereof. For example, the first network function 800 may include a plurality of units, circuities, modules or the like, each of which may be used to perform one or more steps of the example method 600 or one or more steps shown in FIGS. 1-4B related to the first network function (such as the EES(s) 121).

It should be understood that, the first network function may be implemented either as a network element on a dedicated hardware, as a software instance running on a dedicated hardware, or as a virtualized function instantiated on an appropriate platform, e.g. on a cloud infrastructure.

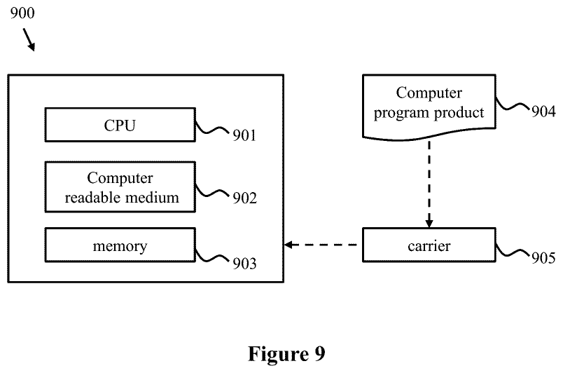

FIG. 9 is a schematic block diagram showing an example computer-implemented apparatus 900, according to the embodiments herein. In an embodiment, the apparatus 900 may be configured as the above mentioned apparatus, such as the UE 101 and its functional component (such as EEC 111 and/or AC 112), the first network function (such as the EES(s) 121), the second network function (such as the EAS(s) 122), or the third network function (such as the ECS 103).

In an embodiment, the apparatus 900 may include but not limited to at least one processor such as Central Processing Unit (CPU) 901, a computer-readable medium 902, and a memory 903. The memory 903 may comprise a volatile (e.g., Random Access Memory, RAM) and/or non-volatile memory (e.g., a hard disk or flash memory). In an embodiment, the computer-readable medium 902 may be configured to store a computer program and/or instructions, which, when executed by the processor 901, causes the processor 901 to carry out any of the above mentioned methods.

In an embodiment, the computer-readable medium 902 (such as non-transitory computer readable medium) may be stored in the memory 903. In another embodiment, the computer program may be stored in a remote location for example computer program product 904 (also may be embodied as computer-readable medium), and accessible by the processor 901 via for example carrier 905.

The computer-readable medium 902 and/or the computer program product 904 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Study 3GPP TR 23.700-98 v0.4.0 (2021-12).

Title: Constraint device in EDGEAPP

### INTRODUCTION

This contribution proposes a new solution to support constraint device in EDGEAPP.

### Reason for Change:

This pCR proposes a new solution to minimize the power consumption in the UE (e.g. move computing task to network side).

### Proposed Changes:

***1st Change*** (the proposed change includes the following the content to be added to the 3GPP Technical Study 23.700-98)
7.x Solution #XX: Constraint device in EDGEAPP
7.x.1 Architecture enhancements
None.
7.x.2 Solution description

This solution addresses KI #15. In this solution, in order to reduce power consumption in the UE, it specifies the EEC with Reduced Capabilities (RedEEC). The RedEEC skips EEC registration and the EAS discovery procedure is enhanced to delegate the EAS selection to EES. FIG. 7.x.2-1 (notes: referring to the above FIG. 2) illustrates the details interactions.

FIG. 7.x.2-1 (notes: referring to the above FIG. 2): service provisioning and EAS discovery for constraint device

In step 1, EEC performs service provisioning. Then the EEC selects those candidate EES(s) not requiring EEC registration in step 2. For EAS discovery, the EEC sends the request to a selected EES from the candidate EES(s) and delegates the EAS selection to EES in step 3. In step 4, the EES performs EAS discovery as described in clause 8.5.2.2 of 3GPP TS 23.558 [2] and in addition selects a suitable EAS from discovered candidate EAS(s), then the EES sends EAS discovery response to the EEC including the selected EAS information. In step 5, if the EAS discovery response contains successful result, the EEC sends to AC the received selected EAS information and the EAS discovery and selection procedure ends; otherwise, the EEC repeats step 3 with next selected candidate EES.

Table 7.x.2-1 and table 7.x.2-1 below show the detailed impact (highlighted with bold text) for EAS discovery request and response.

TABLE 7.x.2-1
EAS discovery request

| Information element | Status | Description |
|---|---|---|
| Requestor identifier | M | The ID of the requestor (e.g. EECID) |
| UE Identifier | O | The identifier of the UE (i.e. GPSI or identity token) |
| Security credentials | M | Security credentials resulting from a successful |
| | | authorization for the edge computing service. |
| EAS discovery filters | O | Set of characteristics to determine required EASs, |
| | | as detailed in Table 8.5.3.2-2. |
| UE location | O | The location information of the UE. The UE location |
| | | is described in clause 7.3.2. |
| Target DNAI (NOTE) | O | Target DNAI information which can be associated |
| | | with potential T-EAS(s) |
| EEC Service Continuity Support | O | Indicates if the EEC supports service continuity or |
| | | not. The IE also indicates which ACR |
| | | scenarios are supported by the EEC or, if this |
| | | message is sent by the EEC to discover a |
| | | T-EAS, which ACR scenario(s) are intended |
| | | to be used for the ACR. |
| EES Service Continuity Support | O | The IE indicates if the S-EES supports service |
| (NOTE) | | continuity or not. The IE also indicates which |
| | | ACR scenarios are supported by the S-EES |
| | | or, if the EAS discovery is used for an S-EES |
| | | executed ACR according to clause 8.8.2.5, |
| | | which ACR scenario is to be used for the |
| | | ACR. |
| EAS Service Continuity Support | O | The IE indicates if the S-EAS supports service |
| (NOTE) | | continuity or not. The IE also indicates which |
| | | ACR scenarios are supported by the S-EAS |
| | | or, if the EAS discovery is used for an S-EAS |
| | | decided ACR according to clause 8.8.2.4, |
| | | which ACR scenario is to be used for the |
| | | ACR. |
| EAS Selection Delegation | O | This IE indicates whether the EAS selection is |
| indication | | delegated to EES. Default value is false if |
| | | omitted. |

(NOTE):
This IE shall not be included when the request originates from the EEC.

TABLE 7.x.2-2
EAS discovery response

| Information | | |
|---|---|---|
| element | Status | Description |
| Successful | O | Indicates that the EAS discovery request |
| response | | was successful. |
| > Discovered | O | List of discovered EAS(s). Each element |
| EAS list | | includes the information described below. |
| >> EAS profile | M | Profile of the EAS. Each element is |
| | | described in clause 8.2.4 |
| >> Lifetime | O | Time interval or duration during which the |
| | | information elements in the EAS profile is |
| | | valid and supposed to be cached in the EEC |
| | | (e.g. time-to-live value for an EAS Endpoint) |
| > Selected | O | Indicates the selected EAS profile by |
| EAS profile | | the EES. |
| Failure | O | Indicates that the EAS discovery request |
| response | | failed. |
| > Cause | O | Indicates the cause of EAS discovery request |
| | | failure. |

In service continuity, to offload UE from monitoring triggers (e.g. location change) to start ACR, EEC can announce its support for EDN side decided ACR scenarios so that EEC only need to passively receive ACR information notifications.
7.x.3 Solution evaluation

This solution addresses KI #15 with improved EAS discovery and selection procedure for constrained device using EDGEAPP. It provides a minimum set of EDGE-1 interactions which helps to reduce power consumption in the UE.

### ***End of Changes***

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### Abbreviations

3GPP 3rd Generation Partnership Project
AC Application Client
ACR Application Context Relocation
EAS Edge Application Server
ECS Edge Configuration Server
ECSP Edge Computing Service Provider
EDN Edge Data Network
EEC Edge Enabler Client
EES Edge Enabler Server
GPSI Generic Public Subscription Identifier
OTT Over The Top
UE User Equipment.

1. A method performed by a first functional component implementing an enabler function in a User Equipment (UE), comprising:
performing a service provisioning, to obtain information regarding one or more first network functions implementing Edge Enabler Servers (EESs);
selecting a first network function from the one or more first network functions;
transmitting, to the selected first network function, a first message including a first parameter enabling the selected first network function to perform Edge Application Server selection; and
receiving, from the selected first network function, a second message.

2. The method according to claim 1, wherein the step of selecting further comprises selecting the first network function which the registration of the first functional component on the first network function is not required.

3. The method according to claim 1, wherein the second message includes a second parameter indicating information regarding a second network function implementing EAS.

4. The method according to claim 3, wherein the first parameter indicates whether the EAS selection is delegated to the selected first network function; and/or
wherein the second parameter indicates the profile of the second network function selected by the selected first network function.

5. The method according to claim 1,
wherein the second message does not include information regarding a second network function implementing EAS,
the method further comprising:
selecting another first network function from the one or more first network functions;
transmitting, to said another first network function, a third message including the first parameter enabling said another first network function to perform Edge Application Server (EAS) selection; and
receiving, from said another first network function, a fourth message including the second parameter indicating information regarding a second network function implementing EAS.

6. A method performed by a first functional component implementing an enabler function in a User Equipment (UE), comprising:
performing a service provisioning, to obtain information regarding one or more first network functions implementing Edge Enabler Servers (EESs);
selecting a first network function from the one or more first network functions, wherein the registration of the first functional component on the selected first network function is not required;
transmitting, to the selected first network function, a first message for discovering a second network function implementing Edge Application Server (EAS); and
receiving, from the selected first network function, a second message.

7. The method according to claim 6, wherein the step of transmitting further comprising:
transmitting, to the selected first network function, a first message for discovering a second network function implementing Edge Application Server (EAS), wherein the first message includes a first parameter enabling the selected first network function to perform EAS selection.

8. The method according to claim 6, wherein the step of receiving further comprising:
receiving, from the selected first network function, a second message including a second parameter indicating information regarding a selected second network function implementing EAS.

9. The method according to claim 6, wherein the second message does not include information regarding a second network function implementing EAS,
the method further comprising:
selecting another first network function from the one or more first network functions;
transmitting, to said another first network function, a third message for discovering a second network function implementing Edge Application Server (EAS); and
receiving, from said another first network function, a fourth message including information regarding a second network function implementing EAS.

10.-12. (canceled)

13. A User Equipment (UE), comprising:
at least one processor; and
a non-transitory computer readable medium coupled to the at least one processor, the non-transitory computer readable medium stores instructions executable by the at least one processor, whereby the at least one processor is configured to perform the method according to claim 1.

14.-16. (canceled)
